(19) United States
(12) Patent Application Publication
(10) Pub. No.: US 2012/0069437 A1
(43) Pub. Date: Mar. 22, 2012

(54) MIXED USE THREE DIMENSIONAL EYEWEAR

(75) Inventors: Arman Bernardi, Glendale, CA (US); Timothy George Stephan, Huntington Beach, CA (US)

(73) Assignee: iCOAT Company, LLC, Santa Fe Springs, CA (US)

(21) Appl. No.: 13/229,905

(22) Filed: Sep. 12, 2011

Related U.S. Application Data
(60) Provisional application No. 61/381,828, filed on Sep. 10, 2010.

(51) Int. Cl. G02B 27/26

(52) U.S. Cl. 359/465

(57) ABSTRACT

3-D eyewear system designed to be worn in association with vertically polarized eyewear (prescription or non-prescription) and method of correcting for vertical polarization for 3-D projections are disclosed. The 3-D eyewear is designed to correct for a vertically polarized underlying optic such that a viewer can use their polarized eyewear while viewing a 3-D stereoscopic movie.

### RELATED APPLICATION

This application claims priority to U.S. Provisional Application 61/381,828 filed Sep. 10, 2010, the disclosure of which is incorporated by reference herein in its entirety.

### FIELD OF THE INVENTION

The present invention relates to mixed-use optical devices that can be used for daily wear (meeting industry standard polarized eyewear specifications such as sun wear, driving glasses, sports glasses, etc. used for reducing reflection and glare outdoors), and for viewing stereoscopic movies and images through the use of a second additional system in front of the polarized eyewear. Specifically, such glare reducing eyewear, optics or glasses for viewing three-dimensional (3-D) stereoscopic movies and images can be used in either prescription or non-prescription uses.

### BACKGROUND OF THE INVENTION

A 3-D (three-dimensional) film or S3D (stereoscopic 3D) film is a motion picture that enhances the illusion of depth perception. Derived from stereoscopic photography, a special camera system is used to record the images as seen from two perspectives (or computer-generated imagery generates the two perspectives), and special projection or display hardware, and appropriate eyewear, are used to provide the illusion of depth when viewing the image.

Stereoscopic images can be produced through a variety of different methods, including anaglyph images, polarization methods, eclipse methods and interference filter technologies. Over the years the popularity of the various systems being widely employed has waxed and waned. However, in recent decades, polarization based 3-D systems have become more common.

In a polarization based system, two images are projected and superimposed onto the same screen through different polarizing fillers (clockwise/counterclockwise, left-handed/right-handed, or vertical/horizontal). In current systems the viewer wears appropriate non-prescription eyeglasses, which also contain a pair of polarizing fillers oriented differently matching the projection's polarizations. As each filler passes only light that is similarly polarized and blocks the light polarized differently, each eye sees a different image. This technique is used to produce a three-dimensional effect by projecting the same scene into both eyes, but depicted from slightly different perspectives. A number of different fillers may be used, including linear or circular polarizing fillers, as long as the different orientations (horizontal vs. vertical or clockwise vs. counterclockwise) used for each eye correctly match the projected images. Typically these polarizing fillers are provided in disposable non-prescription glasses, such as those described in U.S. Pat. Nos. 4,508,526 and 4,400,067, the disclosures of which are incorporated herein by reference.

While viewers that do not require corrective glasses can easily wear existing disposable (cardboard or plastic) framed 3-D eyewear, viewers requiring corrective spectacles have until recently needed to wear existing 3-D eyewear over their corrective spectacles. This combination of eyewear is non-ideal both for comfort and the viewing experience. Reduced image quality results from the 3-D eyewear being unable to provide uniform coverage over each eye due to the size of the corrective spectacles and alignment of both pairs of glasses. Recently manufacturers of 3-D eyewear have addressed this problem by proposing clip-on 3-D eyewear that can be attached to a viewer's underlying corrective optics via some means. One example is the clip-on eyewear disclosed in U.S. Pat. No. 7,524,053, the disclosure of which is incorporated herein by reference.

While these proposals for clip-on 3-D optics address the construction of the glasses and comfort of the viewing experience for people needing corrective eye wear, the clip-on 3-D optics themselves are of standard construction, and are only designed to provide the same polarization to the viewer that would be provided by a standard pair of 3-D glasses. However, industry standard polarized eyewear (such as sun wear, driving glasses, sports glasses, etc.) used for reducing reflection and glare outdoors are themselves polarized. Because the 3-D effect when using a polarization technique requires that the viewer observe the image with the correct polarization, the effect of the additive polarization of the underlying industry standard polarized eyewear is to render the 3-D film unwatchable. Accordingly, for viewers using such industry standard polarized eyewear, it is not possible to use their polarized prescription lenses with standard 3-D glasses or clip-ons.

Whether standard 3-D eyewear is used to watch a 3-D image or a 3-D clip-on is used to watch a 3D image, in neither case can the eyewear be used in a mixed-use manner while meeting the industry standards for vertically polarized eye wear (such as sun wear, driving glasses, sports glasses, etc. used for reducing glare). Thus, it would be advantageous to offer an eye wear system that can function both as industry standard vertically polarized eye wear (such as sun wear, driving glasses, sports glasses, etc. used for reducing glare), and can also be made to function as 3-D eyewear that provides stereoscopic image selection. This new eyewear system can address the needs for both prescription and non-prescription wearers in a similar way as the industry standard polarized eyewear (such as sun wear, driving glasses, sports glasses, etc. used for reducing glare) do today.

### SUMMARY OF THE INVENTION

According to one aspect of the present design, there is provided a set of eyewear for attachment to industry standard vertically polarized eyewear (such as sun wear, driving glasses, sports glasses, etc. used for reducing glare), the attachable eyewear comprising of appropriate wave-retarding optics, formed and configured to compensate for the polarization of the underlying industry standard vertically polarized eyewear (such as sun wear, driving glasses, sports glasses, etc. used for reducing glare) to thereby provide for stereoscopic viewing of images when worn by a user when attached and used in combination.

According to another aspect of the present design, there is provided a set of attachable eyewear for use with polarized eyewear worn by a user when viewing stereoscopic images. The set of attachable eyewear comprises a set of wave retarders, designed to be placed over the underlying polarized eyewear and providing a first orientation (or rotation) along a first orientation and a second orientation (or rotation) along a second orientation that renders the polarization of the underlying eyewear suitable for use in viewing stereoscopic images and movies.

In one aspect of the invention, the mixed-use three-dimensional eyewear includes:

an underlying optic including at least a pair of vertically polarized lenses; and

a polarization correcting optic incorporating one or more wave retarders, the wave-retarders with their own individual retardation levels being oriented to each other and designed to rotate the vertical polarization of the underlying optic to match the polarization of a projected stereoscopic image.

In another such embodiment, the wave retarders are each ¾ wave retarders.

In still another such embodiment, the wave retarder retards in accordance with the equation ¼+N*½, wherein N is any integer.

In yet another such embodiment, the wave retarders are each a combination of partial retarders adding to a ¾ wave retardation.

In still yet another such embodiment the optics further include at least one additional coating selected from the group consisting of scratch resistant hard-coating, color tinting, anti-reflection, anti-fog, transmission-enhancing and mirror finished.

In still yet another such embodiment, at least one of the optics is constructed of a material selected from the group consisting of plastic, hi-index, glass, acrylic and polycarbonate.

In still yet another such embodiment, the polarization correcting optic is detachable from the underlying optic.

In still yet another such embodiment, the polarization correcting optic is attached to the underlying optic using a mechanism selected from the group consisting of slotting into, hanging from, grasping onto, clasping onto, or magnetically attaching thereto.

In still yet another such embodiment, the polarization correcting optic is permanently mounted to the underlying optic.

In still yet another such embodiment, the polarization correcting optic is hingedly attached to the underlying optic.

In still yet another such embodiment,

Another aspect of the invention, provides a method of correcting the vertical polarization of an optic for use with three-dimensional projections including:

providing a polarization correcting optic incorporating one or more wave retarders, the wave-retarders with their own individual retardation levels being oriented to each other and designed to rotate the vertical polarization of the underlying optic to match the polarization of a projected stereoscopic image.

In one such embodiment, the wave retarders are each ¾ wave retarders.

In another such embodiment, the wave retarder retards in accordance with the equation ¼N*½, wherein N is any integer.

In still another such embodiment, the wave retarders are each a combination of partial retarders adding to a ¾ wave retardation.

These and other aspects of the present invention will become apparent to those skilled in the art from the following detailed description of the invention and the accompanying drawings.

### BRIEF DESCRIPTION OF THE DRAWINGS

The present invention is illustrated by way of example, and not by way of limitation, in the figures of the accompanying drawings in which:

FIG. 1 provides a schematic of a standard stereoscopic projection technique;

FIG. 2A provides a schematic of a standard linear polarization scheme.

FIG. 2B provides a schematic of a standard circular polarization scheme;

FIG. 3 provides a schematic of a prior art pair of 3-D eyewear; and

FIG. 4 provides a schematic of an embodiment of a set of mixed-use sun wear and 3-D eyewear in accordance with the present invention.

### DETAILED DESCRIPTION OF THE INVENTION

Reference will now be made in detail to the preferred designs of the invention, examples of which are illustrated in the accompanying drawings. While the invention will be described in conjunction with the preferred designs, it will be understood that they are not intended to limit the invention to those designs. On the contrary, the invention is intended to cover alternatives, modifications, and equivalents, which may be included within the spirit and scope of the invention as defined by the appended claims.

The present invention is directed to 3-D eyewear that is designed to be worn in association with eyewear meeting industry standards for vertically polarized eyewear (such as sun wear, driving glasses, sports glasses, etc. used for reducing glare). Although specific types of 3D projection polarization will be described below, it should be understood that the 3-D eyewear of the instant invention may be designed to correct for any underlying 3D projected polarization such that a viewer can still use their eyewear meeting industry standards for vertically polarized eye wear (such as sun wear, driving glasses, sports glasses, etc. used for reducing glare) while viewing 3-D stereoscopic images.

Industry standard polarized eyewear (such as sun wear, driving glasses, sports glasses, etc. used for reducing glare) are manufactured with linearly polarized optics, and are available in both prescription and non-prescription form, with different colors, photo-chromic capabilities, etc. In all cases the optics are vertically polarized to reduce glare. The reason for this is that while visible light waves from the sun travel in all directions, when this scattered light meets a horizontal surface, like a road or water, a large portion of the light is reflected with horizontal polarization. This horizontally polarized light is seen as white glare and masks light that is useful to the human eye, reducing visibility. Accordingly, by using a vertical polarizing eyewear the horizontally polarized component of the natural light can be significantly attenuated, reducing the overall light level reaching the eye, improving contrast, and thus the perception of the viewer. One example of such eyewear is the PTX4000 lens manufactured by the Polaroid Corporation.

Unfortunately, were such vertically polarized eyewear to be used in conjunction with conventional 3-D eyewear, the vertical polarization of the underlying optics would oppose the angle of polarization of the light being seen by the viewer. If this is not compensated for by the 3-D eyewear, the viewer will be unable to experience the stereoscopic effect of the images being projected. To understand why this is so, it is necessary to first understand how polarized stereoscopic images are created.

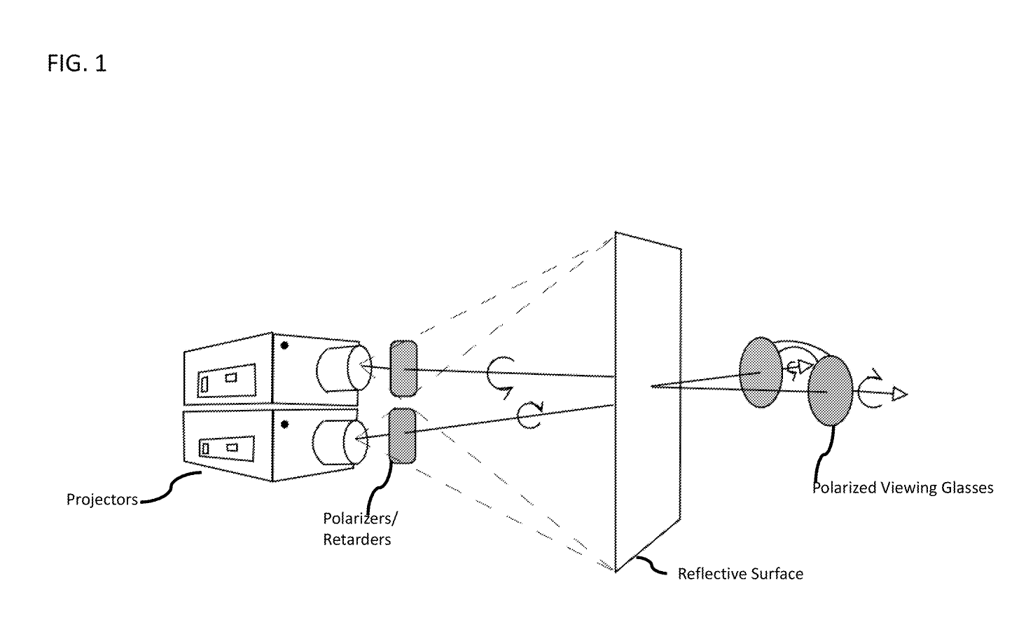

As described above, methods for projecting stereoscopic films with selection devices are well known, and are numerous. (See, e.g., Lipton's Foundations of the Stereoscopic Cinema, 1982, Van Nostrand Reinhold Co. Inc., N.Y., the disclosure of which is incorporated herein by reference.) One well-known and increasingly popular technique is to use polarization fillers. In this technique, as shown schematically in FIG. 1, two images are projected (1) superimposed onto the same screen (2) through different polarizing fillers (3). The viewer wears glasses (4) that also contain a pair of polarizing filters oriented differently (clockwise/counterclockwise, vertical/horizontal, or other angular orientation). As each filter passes only that light that is similarly polarized, and blocks the light polarized differently, each eye sees a different image.

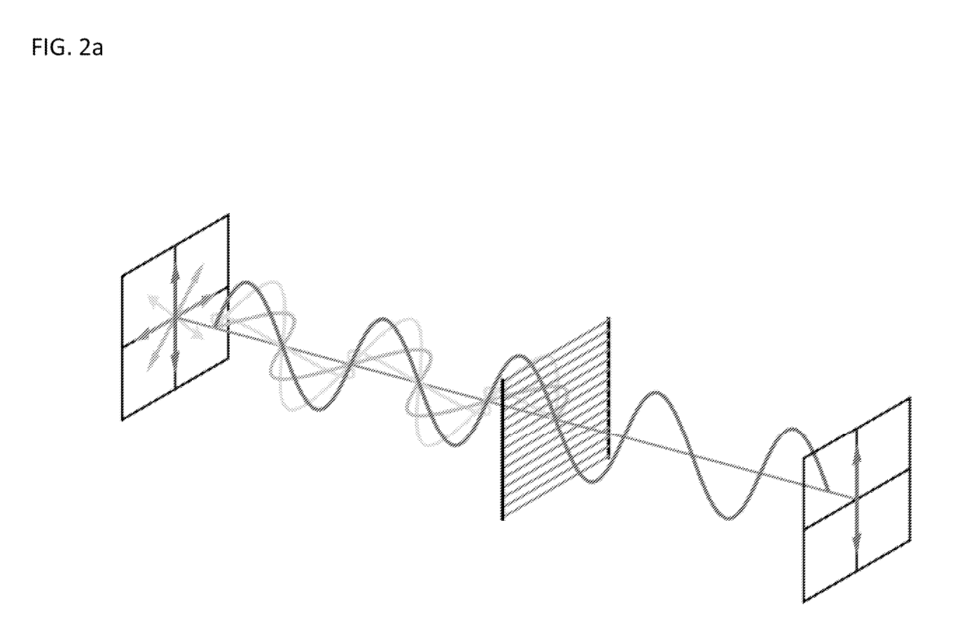

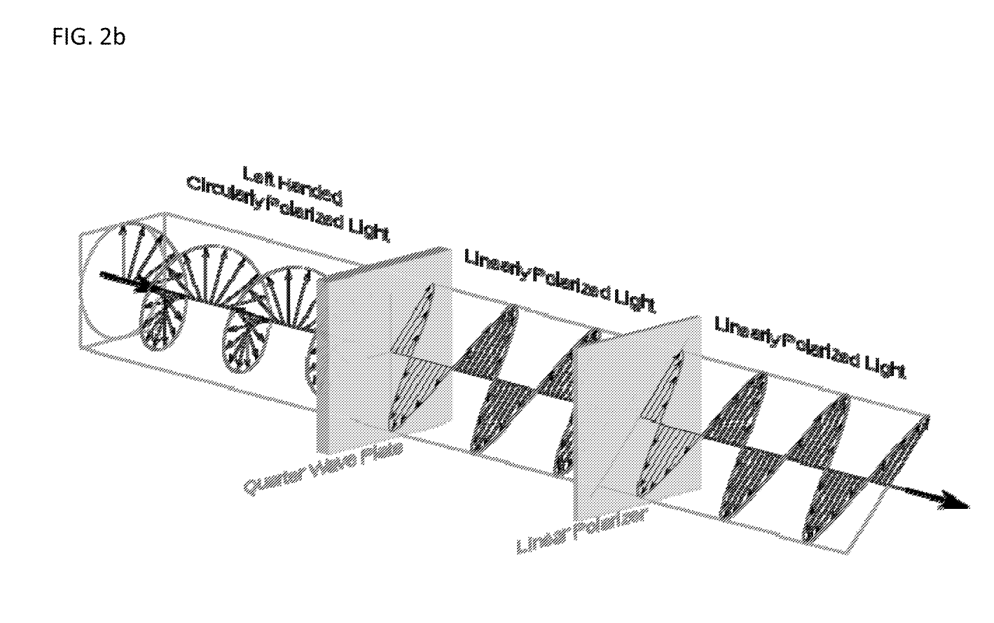

For example, in a linear polarized technique the images are projected superimposed onto the same screen through orthogonal polarizing fillers (e.g. one with vertical polarization and one with horizontal polarization), as shown in FIG. 2a. The viewer wears linearly polarized eyeglasses, which also contain a pair of orthogonal polarizing fillers oriented the same as the projector (e.g. one eye horizontal and one eye vertical). As each filler only passes light which is similarly polarized, and blocks the orthogonally polarized light, each eye only sees one of the projected images, and the 3D effect is achieved. Because of the orthogonal nature of the polarization, linearly polarized glasses require the viewer to keep his or her head level, as tilling of the viewing fillers will cause the images of the left and right channels to bleed over to the opposite channel.

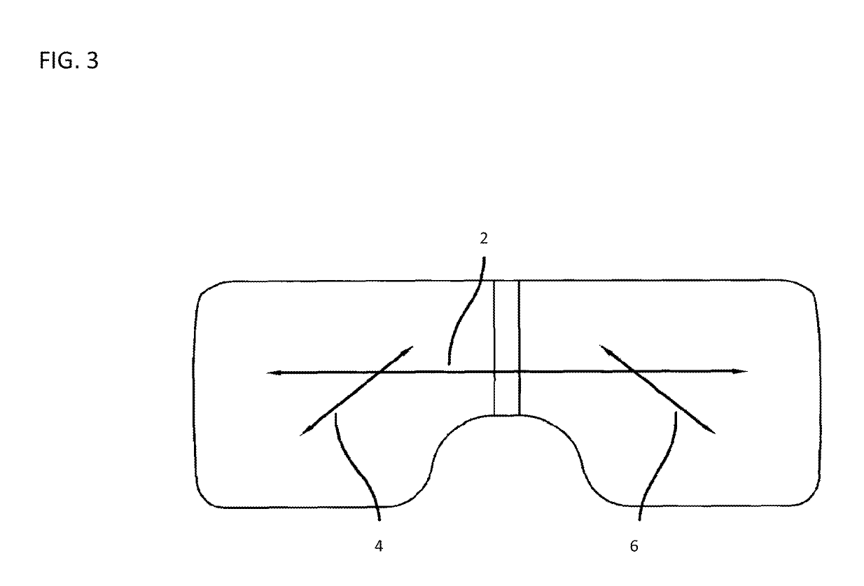

In the case of a circularly polarized technique, such as that marketed by REALD, Inc., a circularly polarizing liquid crystal filler, which can switch polarity, is placed in front of the projector lens. The projector alternately projects right-eye frames and left-eye frames 144 times per second. It circularly polarizes these frames, clockwise for the right eye and counterclockwise for the left eye, as shown in FIG. 2b. As shown in FIG. 3, the viewer wears eyeglasses (5), which contain a pair of analyzing fillers (circular polarizers mounted in reverse) of opposite handedness (6 & 7). Light that is left-circularly polarized is blocked by the right-handed analyzer, while right-circularly polarized light is extinguished by the left-handed analyzer. As shown in the figure, the analyzing fillers are constructed of a quarter-wave plate and a linearly polarized filler. The quarter-wave plate always transforms circularly polarized light into linearly polarized light. It is only the resulting angle of polarization of the linearly polarized light that is determined by the orientation of the fast and slow axes of the quarter-wave plate and the handedness of the incident circularly polarized light.

In operation, as shown in FIG. 2b, the left-handed circularly polarized light entering the polarizer is transformed into linearly polarized light, which has its direction of polarization along the transmission axis of the linear polarizer, and it therefore passes. In contrast right-handed circularly polarized light would have been transformed into linearly polarized light that had its direction of polarization along the absorbing axis of the linear polarizer, which is at right angles to the transmission axis, and it would have therefore been blocked. During a viewing, the 3-D eyewear (FIG. 3), with oppositely circularly polarized lenses, ensure each eye sees only its designated frame. The result is similar to that of stereoscopic viewing using linearly polarized glasses, except the viewer can tilt his or her head and still maintain left/right separation. In this way, circular polarization technology has a distinct advantage over linear polarization methods in that viewers are able to tilt their head and look about the theater naturally without a disturbing loss of 3-D perception, whereas linear polarization projection requires viewers to keep their head orientation aligned within a narrow range of tilt for effective 3-D perception; otherwise they may see double or darkened images.

Obviously in either polarization technique, it is essential that the eyewear lens through which the viewer is looking be polarized to match the polarization of the projected image. And, it is simple matter to provide for such polarization, either by having a viewer wear a standard set of 3-D glasses or by constructing special clip-on 3-D glasses containing standard 3-D optics. However, were the standard 3-D optics to be used in association with underlying vertically polarized optics (such as eyewear meeting industry standards for polarized eyewear (such as sun wear, driving glasses, sports glasses, etc. used for reducing glare), the additive effect of the vertical polarization of the underlying eyewear would alter the polarization of the light reaching the viewer through the 3-D eyewear, meaning that there would be a mismatch between the polarization of light being seen by the viewer and the polarization of the light being projected. As a result, the viewer would not be able to see the stereoscopic images, movies or television as intended. Accordingly, it is not possible to use standard 3-D optics with such vertically polarized eyewear.

The 3-D eyewear of this invention addresses this by using novel wave retardation to correct for the vertical polarization of polarized eyewear meeting applicable industry standards (such as sun wear, driving glasses, sports glasses, etc. used for reducing glare). Specifically, the current invention proposes a mixed use pair of glasses that can be used both as eyewear meeting industry standards for vertically polarized eyewear (such as sun wear, driving glasses, sports glasses, etc. used for reducing glare), and also incrementally as 3-D viewing eyewear (covering needs of both prescription and non-prescription uses).

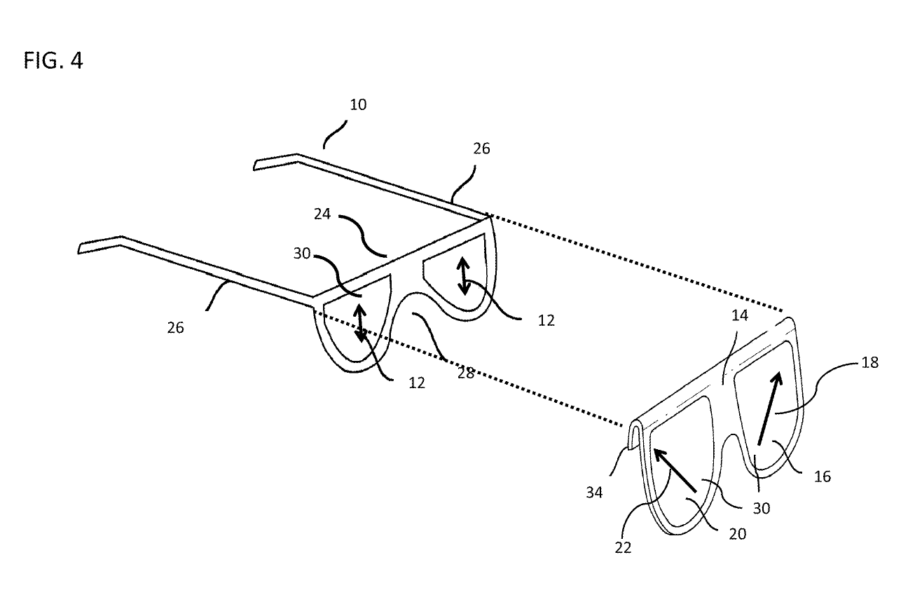

FIG. 4 illustrates the construction method of the combination 3-D eyewear of this invention. Although this exemplary embodiment uses circular polarizing analyzers, as noted earlier, other valid selection devices and techniques may be employed. As seen in FIG. 4, in one embodiment the underlying polarized eyewear (10) is made of a vertical linear polarizing substrate whose axis is indicated by double-headed arrow (12). As discussed above, using vertically polarized lenses means that the eyewear can operate as sunglasses during normal use (for either prescription or non-prescription needs). In order to allow this polarized eyewear to be used to view stereoscopic images and movies, a separate clip-on unit (14) is then provided that is designed to attach to and over the underlying eyewear (10). However, rather than the standard ¼ wave retarder used with conventional 3-D eyewear for circular polarized settings, the current invention in this embodiment uses two ¾ wave retarders one such retarder (16) with axis (18) is applied on the left-hand side of the eyewear, and another ¾ wave retarder (20) with an axis (22) is applied to the right-hand portion of the clip-on. As in standard 3-D eyewear, the axes of these special retarders (18) and (22) are orthogonal. The ¾ wave retarders serve to shift the polarization of the underlying vertically polarized eyewear to match the circular polarizer analyzers of opposite handedness found in standard 3-D eyewear, such as those described in U.S. Pat. No. 7,524,053, the disclosure of which is incorporated herein by reference.

Although one embodiment of the invention using orthogonal ¾ wave retarders is described above, it should be understood that many possible levels of retardation and angular orientations of retarder/polarizer axes may be employed per eye so long as the underlying eye wear polarizer is vertical so that it may be used as a glare reducing optic in normal use meeting industry standards for vertically polarized eye wear (such as sun wear, driving glasses, sports glasses, etc. used for reducing glare). For example, the clip-on may be triple stacked with three ¼ polarizers, or with singular ¾ polarizers, or any other combination of retarders that provides an end polarization that matches that required for a particular stereoscopic viewing technique. One way of expressing such combinations of retarders mathematically is via the formula: ¼+N*½, wherein N is any integer.

In addition, it should be understood that additional coatings may be applied as well, including tinting, anti-reflection, anti-fog, transmission-enhancing, mirrored finished, etc. that do not impact the polarization of the lenses. Moreover, it should also be understood that the retarding filters (clip-ons), and underlying eyewear can be constructed of any suitable optics material, such as, for example, plastics, hi-index, glass, acrylic, polycarbonate, etc. to achieve desired thicknesses, hardnesses, optical clarity, etc.

Finally, although an embodiment of an underlying polarized optic and a clip-on 3-D optic is shown in FIG. 4, it should be understood that the eyewear shown in FIG. 4 is meant to be a generic representation, as many variations of these designs have been developed. Any shape or design of rim (24), temple (26), nose bridge and nose pads (28), and lens (30) may be incorporated into the underlying polarized optic (10). Likewise, any shape or design of lens (30) and attachment mechanism (34) may be incorporated into the clip-on 3-D optic (14). For example, the clip-on may slot into, hang from, grasp, clasp or magnetically attach onto the front of the underlying eyewear using any known attachment mechanism. Alternatively, the clip-on optic may be permanently attached to the underlying polarized eyewear, or be hinged to allow the clip-on to flip-down over the underlying eyewear. Moreover, both the underlying eyewear and the clip-on may be straight or curved as desired. And, both the underlying and clip-on eyewear may be made of any suitable material, such as, for example, plastic, metal or wood. The only requirement being that the clip-on 3-D optic be attachable to the underlying polarized optic, and that when in the designed position modify the polarization of the underlying eyewear so that they may be utilized for stereoscopic viewing.

The invention is also directed to a method of correcting for underlying vertically polarized optics comprising providing two orthogonal ¾ wave retarders, one applied on the left-hand side of the eyewear, and another applied to the right-hand portion of the clip-on. As with the above described embodiment, it should be understood that many possible levels of retardation and angular orientations of retarder/polarizer axes may be employed, such as, for example, a triple stack with three ¼ polarizers, or with singular ¾ polarizers, or any other combination of retarders in accordance with the equation ¼+N*½, wherein N is any integer, that provides an end polarization that matches that required for a particular stereoscopic viewing technique.

By the foregoing description, an improved 3-D stereoscopic eyewear system has been described. The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

What is claimed is:

1. A set of mixed-use three-dimensional eyewear comprising:
an underlying optic comprising at least a pair of vertically polarized lenses; and
a polarization correcting optic incorporating one or more wave retarders, said wave-retarders with their own individual retardation levels being oriented to each other and designed to rotate the vertical polarization of the underlying optic to match the polarization of a projected stereoscopic image.

2. The three-dimensional eyewear of claim 1, wherein the wave retarders are each ¾ wave retarders.

3. The three-dimensional eyewear of claim 1, wherein the wave retarder retards in accordance with the equation ¼+N*½, wherein N is any integer.

4. The three-dimensional eyewear of claim 1, wherein the wave retarders are each a combination of partial retarders adding to a ¾ wave retardation.

5. The three-dimensional eyewear of claim 1, wherein at least one of the optics further includes at least one additional coating selected from the group consisting of scratch resistant hard-coating, color tinting, anti-reflection, anti-fog, transmission-enhancing and mirror finished.

6. The three-dimensional eyewear of claim 1, wherein at least one of the optics is constructed of a material selected from the group consisting of plastic, hi-index, glass, acrylic and polycarbonate.

7. The three-dimensional eyewear of claim 1, wherein the polarization correcting optic is detachable from the underlying optic.

8. The three-dimensional eyewear of claim 1, wherein the polarization correcting optic is attached to the underlying optic using a mechanism selected from the group consisting of slotting into, hanging from, grasping onto, clasping onto, or magnetically attaching thereto.

9. The three-dimensional eyewear of claim 1, wherein the polarization correcting optic is permanently mounted to the underlying optic.

10. The three-dimensional eyewear of claim 1, wherein the polarization correcting optic is hingedly attached to the underlying optic.

11. A method of correcting the vertical polarization of an optic for use with three-dimensional projections comprising:
providing a polarization correcting optic incorporating one or more wave retarders, said wave-retarders with their own individual retardation levels being oriented to each other and designed to rotate the vertical polarization of the underlying optic to match the polarization of a projected stereoscopic image.

12. The method of claim 11, wherein the wave retarders are each ¾ wave retarders.

13. The method of claim 11, wherein the wave retarder retards in accordance with the equation ¼+N*½, wherein N is any integer.

14. The method of claim 11, wherein the wave retarders are each a combination of partial retarders adding to a ¾ wave retardation.
